(19) United States
(12) Patent Application Publication
(10) Pub. No.: US 2006/0290074 A1
(43) Pub. Date: Dec. 28, 2006

(54) Quick-closing door for pressure vessels

(76) Inventors: Mehmet Ozdeslik, Istanbul (TR); Peter Schmetz, Menden (DE)

Correspondence Address: Robert W Becker & Associates, 707 Hwy 66 East, Suite B, Tijera, NM, 87059-7382, US

(21) Appl. No.: 10/554,784

(22) PCT Filed: Jan. 13, 2004
(86) PCT No.: PCT/TR04/00002

§ 371 Date: Oct. 28, 2005

(30) Foreign Application Priority Data
Apr. 30, 2003 (TR) 2003/00572

(51) Int. Cl. F16J 15/00

(52) U.S. Cl. 277/628

(57) ABSTRACT

A sealing system for quick-closing doors of pressure vessels, either by providing under pressure from both sides of a gasket, or by using overpressure between two special gaskets.

### BACKGROUND OF THE INVENTION

This kind of door is well known, e.g. it is used for hot-air-autoclaves, autoclaves for steam curing and for heat treatment of metals under protective atmosphere in overpressure- and underpressure ranges of −1/+20 or more bar.

As long as the protective atmosphere is inert, it is no problem to vary the process pressure during operation from underpressure to overpressure and visa versa.

In case, that the protective atmosphere is burnable or explosive when it is mixed with oxygen, safety questions have to be considered.

The quick-closing doors are equipped with a special gasket, which ensures safe operation when the vessel is on overpressure as well as when it is at underpressure. A risk is seen at ambient pressure in the vessel, when no pressure—difference is sealing the gasket.

For safe use of the pressure vessels with quick-closing doors, in case of variable inner pressure from underpressure to overpressure and with burnable atmosphere, e.g. hydrogen, measurements have to be found, which avoid a leakage at ambient pressure, and which gave alarm, when a leakage should occur.

### BRIEF SUMMARY OF THE INVENTION

The aim of the present invention is to propose a sealing system for quick closing doors for pressure vessels, enabling the disadvantages described above to overcome.

Two different ways were found for safe sealing also for the use of hydrogen atmosphere in the pressure vessel.

The first method is to use underpressure from both sides of the gasket to avoid penetration of hydrogen to the ambient air, or of air into the pressure vessel.

The second method is to use overpressure between two special gaskets, which keeps the sealing tight, independent of the pressure in the vessel.

In both cases the function of the sealing will be continuously measured, and a signal of any malfunction would bring the pressure vessel into a safe mode.

### BRIEF DESCRIPTION OF THE DRAWINGS

FIG. 1 is a cross section along the center line of the quick-closing door of a pressure vessel in the existing design.

FIG. 2 is showing the sealing area in a larger scale.

FIG. 3 is a cross section along the center line of the quick-closing door of a pressure vessel with underpressure design.

FIG. 4 is showing the sealing area of FIG. 3 in a larger scale.

FIG. 5 is a cross section along the center line of the quick-closing door of a pressure vessel with overpressure design.

FIG. 6 is showing the sealing area of FIG. 5 in a larger scale.

FIG. 7 is a front view of a quick-closing door of a pressure vessel.

### DETAILED DESCRIPTION OF THE INVENTION

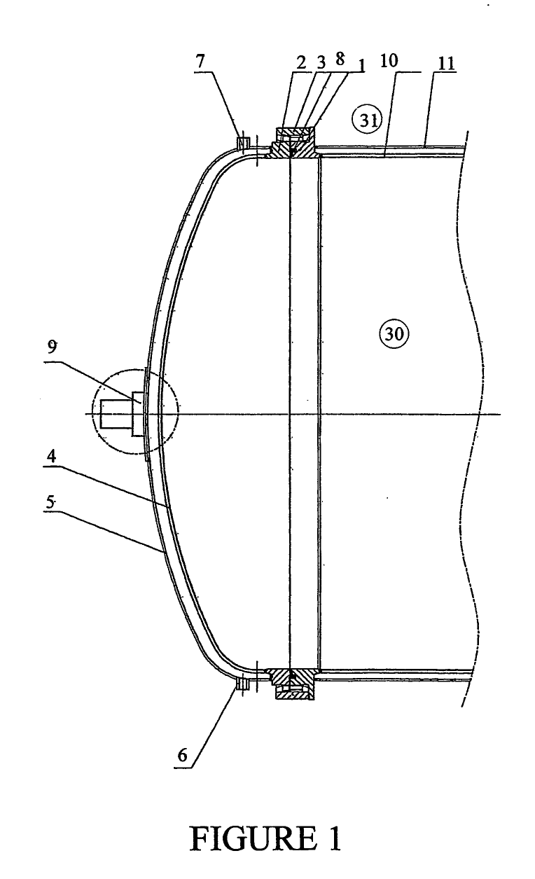

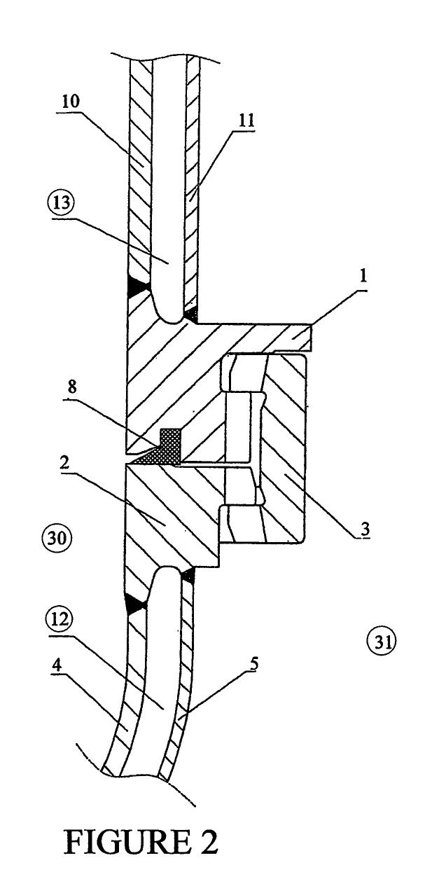

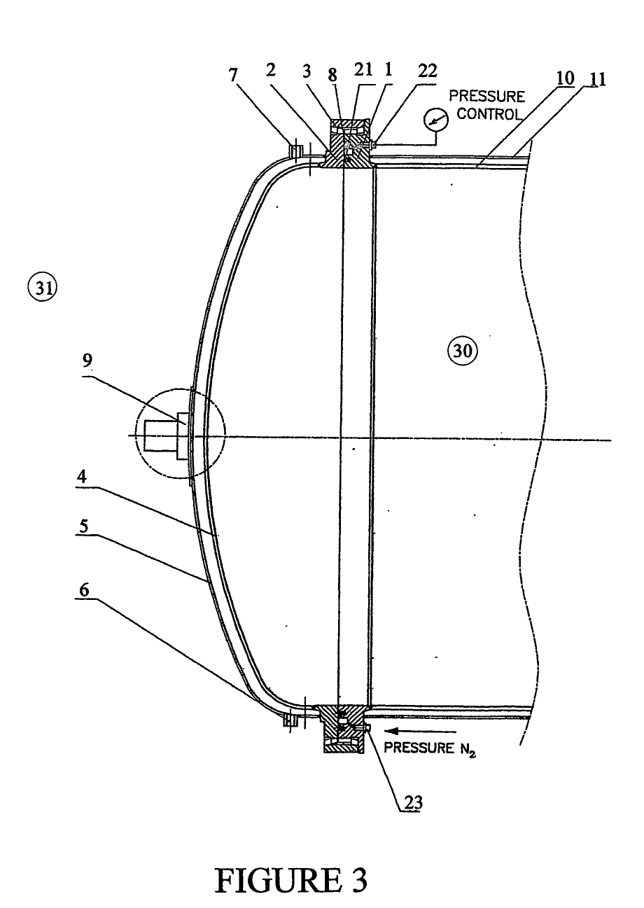

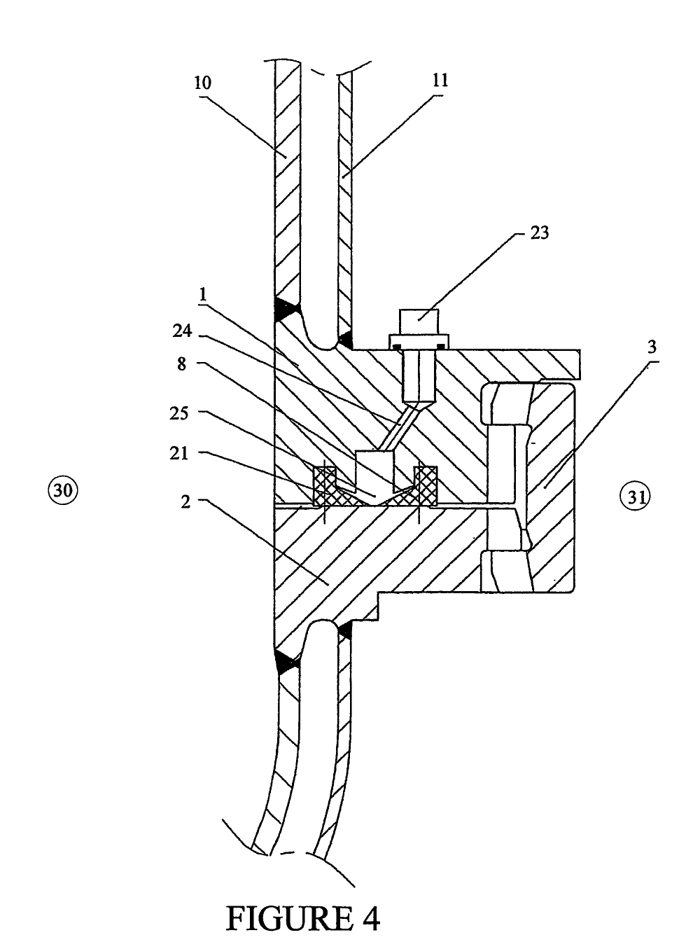

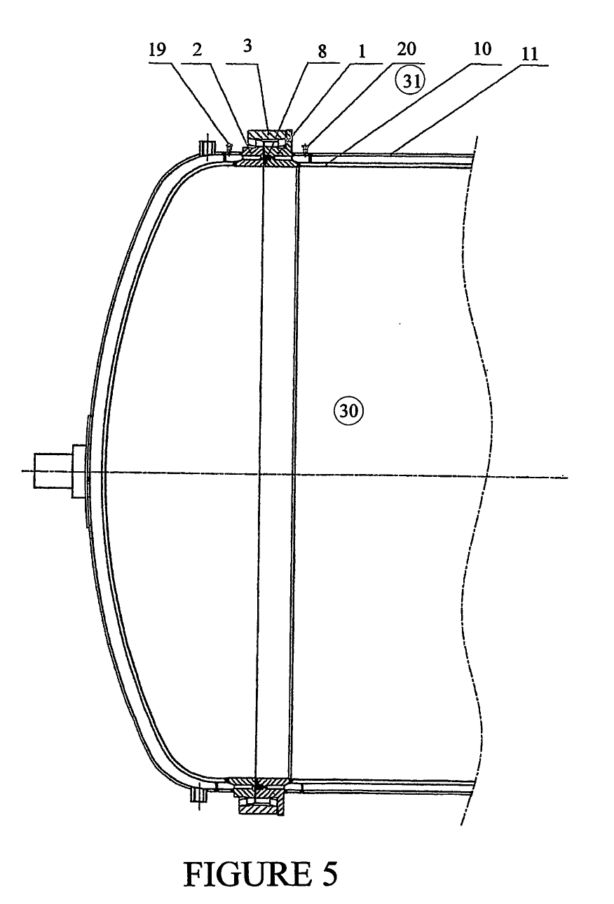

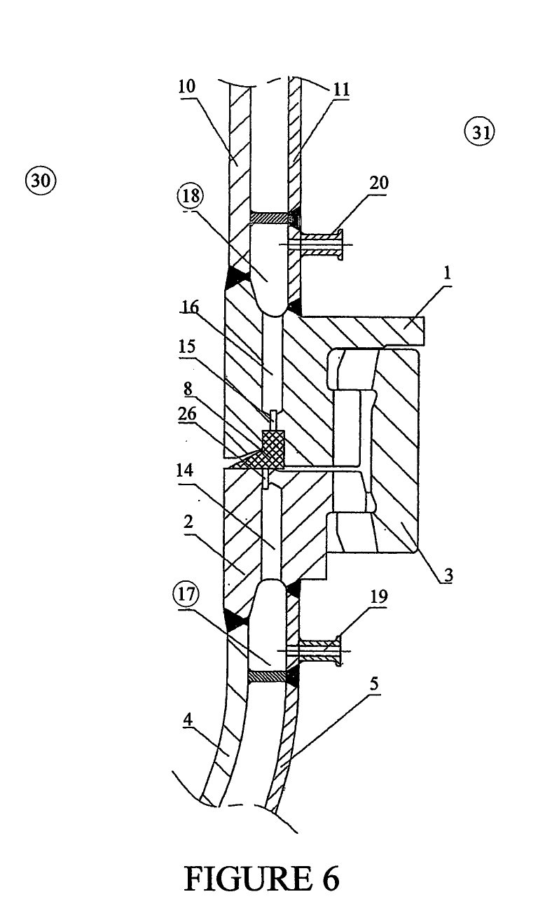

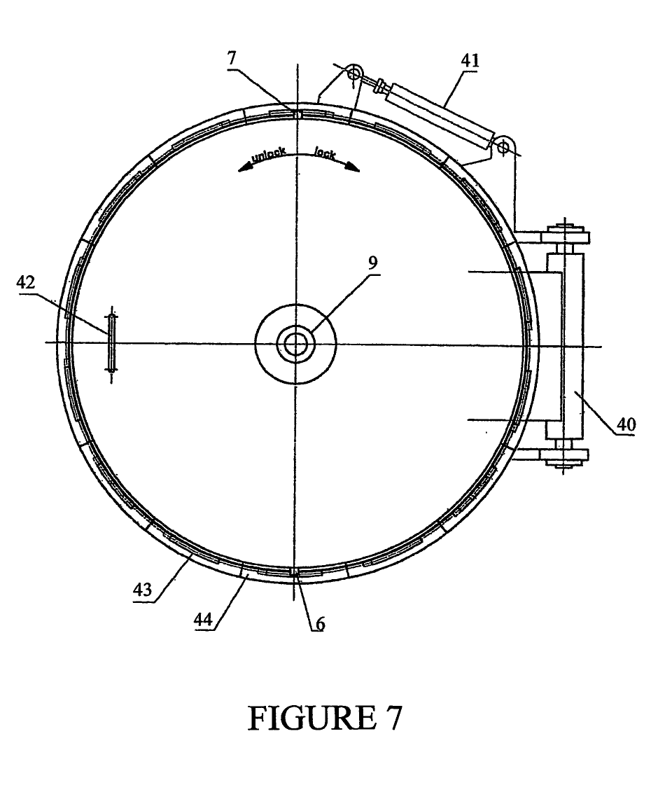

In the various figures, the same reference numbers designate identical elements, e.g. number 1 designates always the flange of the pressure vessel, even when the flange has different design in the FIGS. 1-7.

The invention relates to a method of sealing quick-closing doors 2, 4, 5, 6, 7, 9 for pressure vessels 1, 10, 11 which are locked by a turnable ring 3 and sealed with a lip-gasket 8, and waterjacket all around 12, 13.

The inner space 30 of the vessel contains the load which has to be treated, devices for heating, cooling thermal isolation, an atmosphere of protection-, or reaction-gas, gas circulating and gas guiding systems.

Compared with the ambient atmosphere 31, the inner pressure can be underpressure, overpressure, or as well ambient pressure.

When the inner pressure is at underpressure, the ambient pressure presses the door towards the gasket and makes it tight.

When the inner pressure is at overpressure, this pressure presses the lip of the gasket to the doorflange 2, and also makes it tight.

When the inner pressure is at ambient pressure, the sealing in undefined and this can create danger, if the atmosphere consists of burnable gas, e.g. hydrogen.

According to the invention, a first method is suggested to get a safe sealing by using two gaskets 8, 21, and an overpressure space 24, 25, with a fitting 23 for a connection to a nitrogen source, which supplies a pressure in space 25, which is 1, 2 to 2, 0 times so high, as the maximum pressure in the vessel 30.

The pressure in space 25 will press the lips of the gaskets to the flange 2 of the door, and will give tight sealing of the pressure vessel independent of the inner pressure. The pressure in space 25 will be continuously controlled during the whole process in the vessel, by connecting the pressure space via a fitting 22 with a pressure controller with alarm switch.

In case of any malfunction the vessel will be brought into safe mode, depending on the actual stage of the process in the vessel, which can mean purging with nitrogen or backfilling with nitrogen and/or stopping the process.

A second method is suggested to get safe sealing by having an underpressure space 15, 16, 18 around the gasket 8 on the flange 1 of the pressure vessel, and an underpressure space 26, 14, 17 around the gasket on the flange 2 of the door. This underpressure space will be connected by flanges 19, 20 with a suction pump, and the pressure will be in the range of 1-50 mbar, and will be continuously controlled. In case of a leakage at the gasket, the underpressure controller will give a signal to bring the vessel in safe mode, depending on the actual stage of the process in the vessel.

For loading and unloading, the door can be opened after bringing the inner pressure and the overpressure or underpressure spaces at the gaskets to ambient pressure, turning the locking ring 3 with a hydraulic cylinder 41, till the clamping teeth 44 are in the gaps 43, by pulling the handle 42 and turning the door around the hinge 40.

1-4. (canceled)

5. A system for sealing a quick-closing door of a pressure vessel for safe use of such vessel, even with an atmosphere of burnable gases and with variable inner pressure, namely underpressure, ambient pressure and overpressure, comprising:
two lip-gaskets provided in a flange of said pressure vessel and adapted to rest against a flange of said door, wherein said gaskets face one another and are separated from one another by a space that is connected to a nitrogen source for supplying to said space a pressure that is 1.2 to 2.0 times as great as a maximum pressure in said pressure vessel, and wherein said pressure is adapted to press lips of said gaskets against said door flange to provide a tight seal between said pressure vessel and said door independent of a pressure within said pressure vessel.

6. The system according to claim 5, further comprising a tightness-control system that is adapted to continuously measure an overpressure between said gaskets and to provide a signal if the measured value is not within an acceptable range, wherein in conformity with said signal a supervisor system is adapted to automatically bring said vessel into safe mode.

7. A system for sealing a quick-closing door of a pressure vessel for safe use of such vessel, even with an atmosphere of burnable gases and with variable inner pressure, namely underpressure, ambient pressure and overpressure, comprising:
a gasket provided in a flange of said pressure vessel and adapted to rest against a flange of said door, wherein said gasket communicates with a first underpressure space provided in said flange of said pressure vessel and with a second underpressure space provided in said flange of said door, wherein said underpressure spaces are connected to a suction pump for providing an underpressure in the range of 1-50 mbar, and wherein said underpressure is adapted to pull said gasket against said flange of said pressure vessel and against said flange of said door to provide a tight seal between said pressure vessel and said door independent of a pressure within said pressure vessel.

8. A system according to claim 7, further comprising a tightness-control-system that is adapted to continuously measure an underpressure at said gasket and to provide a signal if the measured underpressure value is not within an acceptable range, wherein in conformity with said signal a supervisor system is adapted to automatically bring said vessel into safe mode.
